(19) United States
(12) Patent Application Publication
(10) Pub. No.: US 2022/0390241 A1
(43) Pub. Date: Dec. 8, 2022

(54) Device for Determining a Parking Position for a Motor Vehicle

(71) Applicant: Bayerische Motoren Werke Aktiengesellschaft, Muenchen (DE)

(72) Inventor: Felix KLANNER, Muenchen (DE)

(21) Appl. No.: 17/775,027

(22) PCT Filed: Oct. 26, 2020
(86) PCT No.: PCT/EP2020/079982

§ 371 Date: May 6, 2022

(30) Foreign Application Priority Data
Dec. 6, 2019 (DE) 10 2019 133 290.7

(51) Int. Cl. G01C 21/34

(52) U.S. Cl. CPC G01C 21/3407

(57) ABSTRACT

A device determines a parking position for a motor vehicle. The device has a receiver unit for receiving a desired parking position of a first user, an output unit for outputting a parking position for the motor vehicle of the first user, and a processing unit which is designed, on the basis of historical data and current data, to determine the probability that the desired parking position of the first user matches the desired collection position of a second user, and which is designed to determine a parking position for the motor vehicle of the first user on the basis of the probability, the output unit being designed to output the parking position.

### BACKGROUND AND SUMMARY

The invention relates to a device for determining a parking position for a motor vehicle. The invention additionally relates to a motor vehicle having such a device and to a method for determining a parking position for a motor vehicle.

In particular in the case of motor vehicle fleets, e.g. in the field of car sharing, it is theoretically possible to hand over a motor vehicle directly from one user to the next user without having to park the motor vehicle. However, the probability of another user wishing to take over a motor vehicle at a particular address exactly at the correct time is very low. Although there are locations at which the probability is significantly higher, for example at airports, parking of motor vehicles is not permitted in certain areas because of traffic regulations or by the operator in the case of car sharing providers.

Although systems used hitherto have the opportunity to notify a current driver and a future driver of the point at which the current vehicle may be handed over, it is frequently necessary for a motor vehicle to be parked in these cases because the new driver does not appear at the specified meeting point. This may lead to a current user having to park the motor vehicle at a position at which there are few parking options and at which the probability of the vehicle being able to be handed over to a new user directly without prior arrangement is low.

The invention is thus based on the object of providing a device that allows a user to be provided with a display indicating a parking position for a motor vehicle at which there is a high probability of the vehicle being able to be handed over to another user directly, preferably even without prior arrangement.

This object is achieved by a device for determining a parking position and by a motor vehicle having such a device in accordance with the independent claims.

The device for determining a parking position for a motor vehicle has a receiving unit for receiving a desired parking position of a first user and an output unit for outputting a parking position for the motor vehicle of the first user. By way of example, the desired parking position of the first user may be input by way of a navigation unit of the motor vehicle. The desired parking position may be consistent with the time of routing.

In order to guarantee that the parking position is a position at which there is a high probability of the motor vehicle being able to be handed over from the first user directly to a second user, the device has a processing unit that is configured to take historical data and current data as a basis for determining a probability of the desired parking position of the first user matching the desired pickup position of a second (potential) user. The processing unit may subsequently determine a parking position for the motor vehicle of the first user on the basis of the probability, and the output unit may then output the parking position as the new destination position.

A parking position in this context is understood to mean in particular a location at which the motor vehicle may be parked in the short term in order to allow a change from one user, or driver, to another user, or driver. That is to say that this merely requires the motor vehicle to stop at the parking position, without parking.

The output unit may display the parking position for the motor vehicle for example in the navigation unit as a destination position. The displayed destination position no longer has to correspond to the desired parking position of the first user in this case, but rather may have been adapted by the determination of the probability, as described above.

In this way, it is possible for the user to be provided with an indication of a parking, or destination, position at which there is a high probability of a second user taking over the motor vehicle directly, in order to avoid the first user having to look for a parking space. It is therefore not necessary to arrange with a second user, i.e. a subsequent car sharing customer, when and where the vehicle will be handed over before or when actually starting a journey. On the contrary, this is possible without prior arrangement or with arrangement that can even take place a few minutes before the vehicle is ready for handover.

According to one embodiment, the processing unit is configured to determine the parking position in a predefined area around the desired parking position of the first user. By way of example, the parking position may be in an area 50 m around the desired parking position of the first user. The predefined area may be firmly set from the start and/or may be adapted by the first user. By way of example, the user may input the area using the input unit. In this way, it is possible to guarantee that the first user, after parking the vehicle, only has to cover a distance that is acceptable to him in order to get to his actual desired parking position.

In particular, the parking position may be determined in such a way that the probability of the parking position matching a desired pickup position of a second user is above a stipulated threshold. The stipulated threshold may preferably be over 80%, particularly preferably over 90%. This makes it possible to guarantee that there is a very high probability of it not being necessary to park the vehicle, but rather of the first user being able to hand over directly to a second user. Appropriate selection of the parking position allows the destination position of the first user to be finely adjusted in such a way that the probability of the vehicle being able to be handed over to a new, second user at the destination position directly is maximized.

According to a further embodiment, the historical data include information about actual pickup positions and/or parking positions of motor vehicles in the past. This information may contain both temporal and geographical information. This information may be available as a heatmap indicating where (i.e. geographically) at the present time (as the temporal component) there is the best possibility of smooth vehicle handover without looking for a parking space. The past pickup positions and/or parking positions of motor vehicles may be determined and stored by monitoring all of the motor vehicles of a motor vehicle fleet. This monitoring may be used continuously in order to extend the historical data and, if necessary, to adapt a heatmap.

According to a further embodiment, the processing unit is configured to determine the parking position by using geographical information, in particular parking areas and/or road sizes. In this way, in addition to an optimum parking position based on the probability of smooth vehicle transfer being possible, it is also possible to take into consideration whether it is possible to park the vehicle according to the traffic regulations. In particular, this can involve using parking positions that have parking areas, or at least smaller roads in which it is also readily possible to stop at the roadside. This likewise simplifies the handover between two users.

The processing unit may additionally be configured to compare the desired parking position of the first user with a current desired pickup position of a second user and to take the comparison as a basis for determining the parking position. These embodiments also allow current search queries after a vehicle to be taken into consideration in addition to historical data indicating where there is, theoretically, a high probability of a vehicle being able to be handed over directly. This further increases the probability of a direct vehicle handover being able to be performed.

If a direct handover is envisaged on the basis of a current search query of a second user, the processing unit may additionally compare a route from a current position of the first user to the desired parking position of the first user with a route from the desired pickup position of the second user to the desired parking position of the first user and take the comparison as a basis for stipulating the parking position along the route from the desired pickup position of the second user to the desired parking position of the first user. In this case, the parking position may be stipulated in such a way that a handover of the vehicle from the first user to the second user takes place over the actual route of the first user and the second user subsequently takes along the first user on to his actual desired parking position. This can allow optimum use of a vehicle, since the distance needs to be covered only once.

According to a further embodiment, the processing unit is configured to determine the probability of the desired parking position of the first user matching the desired pickup position of a second user on the basis of already known future desired pickup positions. By way of example, the second user may announce when he needs a motor vehicle hours or days in advance. In particular after a flight, i.e. at the airport, the desired pickup position, with a time, may be indicated by the second user in advance. This may be stored in a database, and the processing unit may, when determining a parking position for the first user, take into consideration such requirements for a motor vehicle that have already been planned for the future. The requirement of the second user may also be adapted on the basis of a delay to the flight, and the processing unit may then accordingly also adapt the parking position for the first user.

The device described above allows the first user to be provided with a display indicating a destination position by way of the output unit, sometimes with an indication of the probability of a direct handover of the vehicle being possible, an indication of the probable waiting time before a direct handover of the vehicle is possible, an indication of whether a direct handover to a second user who has requested a vehicle is to take place, and at what time such a handover is to take place.

According to a further aspect, a motor vehicle having a device as described above is proposed.

By way of example, the device may be integrated in the navigation unit of the motor vehicle or may be provided as a separate device having appropriate input and output means.

According to one embodiment, the motor vehicle has a monitoring unit for monitoring the interior of the motor vehicle. Such a monitoring unit, which may be a camera, for example, allows safety to be increased in particular in cases in which the first user and the second user are sitting in the motor vehicle at the same time. As described above, this may be the case if the handover of the motor vehicle takes place on a route between the desired parking position of the first user and the desired pickup position of the second user and the second user is taking the first user to his desired position.

According to a further aspect, a method for determining a parking position for a motor vehicle is proposed, the method comprising the following steps: receiving a desired parking position of a first user, on the basis of historical data and current data, determining a probability of the desired parking position of the first user matching the desired pickup position of a second user, determining a parking position for the motor vehicle of the first user on the basis of the probability, and outputting the parking position for the motor vehicle of the first user.

The embodiments and features described for the proposed device apply to the proposed method accordingly.

Furthermore, a computer program product is proposed that comprises a program code designed to prompt performance of the method as outlined above on a computer.

A computer program product, such as e.g. a computer program means, may be provided or supplied for example as a storage medium, such as e.g. a memory card, USB stick, CD-ROM, DVD, or in the form of a downloadable file from a server in a network. This may be done for example in a wireless communication network by way of the transmission of an appropriate file containing the computer program product or the computer program means.

Further possible implementations of the invention also encompass not explicitly mentioned combinations of features or embodiments described above or below with respect to the exemplary embodiments. A person skilled in the art will also add individual aspects as improvements or supplementations to the respective basic form of the invention.

Further advantages and advantageous embodiments are indicated in the description, the drawings and the claims. In particular the combinations of features that are indicated in the description and in the drawings are purely exemplary, and so the features may also be present individually or in other combinations.

The invention will be described in more detail below on the basis of exemplary embodiments illustrated in the drawing. The exemplary embodiments and the combinations shown in the exemplary embodiments are purely exemplary and are not intended to establish the scope of protection of the invention. This scope is defined solely by the dependent claims.

### BRIEF DESCRIPTION OF THE DRAWING

FIG. 1 is a schematic block diagram of a motor vehicle.

Elements that are identical or have an identical effect in functional terms are denoted by the same reference signs below.

### DETAILED DESCRIPTION OF THE DRAWING

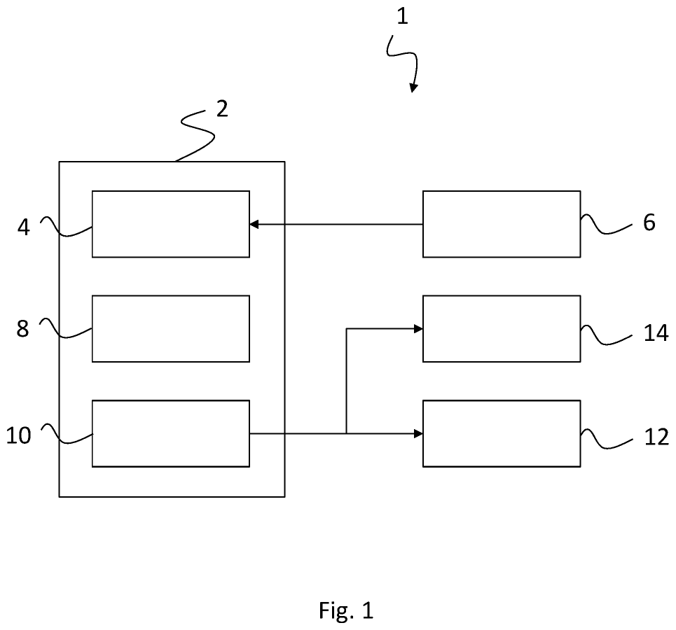

FIG. 1 shows a motor vehicle 1 that has a device 2 for determining a parking position for the motor vehicle 1. The motor vehicle may be in particular a car sharing vehicle that is part of a motor vehicle fleet.

So as, if possible, to allow a direct handover from a first user to a second user of the motor vehicle, the device 2 is configured to determine a parking position of the motor vehicle 1 at which there is a high probability of a direct handover from the first user to a (potential) second user being possible.

The first user is the current driver of the motor vehicle 1, who, if possible, wishes to hand over the motor vehicle 1 directly to a second user. In this way, the first user does not need to park the motor vehicle 1 and thus look for a parking space.

The device 2 has an input unit 4 in order to receive a desired parking position of the first user. The desired parking position may be for example the actual destination position of the first user. The first user may input the desired parking position using an input device 6 of the motor vehicle 1. The input device 6 may be for example an input 6 of a navigation unit, for example a touchscreen or another input device such as a keypad. The desired parking position may also be input by the user as a voice input.

Based on the desired parking position that has been input, a processing unit 8 of the device 2 may determine a parking position. To this end, the processing unit 8 may use historical data and current data, in order to take these as a basis for determining a probability of the desired parking position of the first user matching the desired pickup position of a second user. In particular, the processing unit 8 may determine as the parking position a position in a predefined area around the desired parking position of the first user in which there is a high probability of a second user in this area needing a motor vehicle. The historical data may be generated by other vehicles of the motor vehicle fleet.

The historical data are in particular actual parking positions and pickup positions of motor vehicles of the motor vehicle fleet in the past. These may be taken into consideration on both a geographical and a temporal basis in a heatmap. In addition to the historical data, the processing unit 8 may also take into consideration current data. The current data may be primarily current search queries from potential second users after a motor vehicle 1.

As soon as the processing unit 8 has determined a parking position for the motor vehicle 1, an output unit 10 of the device 2 may output this parking position as the new destination position by way of an output device 12. The output device may be for example a screen or the like that is for example part of a navigation unit.

When determining the parking position, the processing unit 8 may also stipulate that a handover of the motor vehicle 1 from the first user to the second user takes place on a route of the first user. This is the case if the desired pickup position of the second user is on the road from a current position of the first user to the desired parking position of the first user. In this case, there may be provision for the second user to take along the first user in the motor vehicle 1. This allows optimum utilization of the motor vehicle 1, since no distances need to be covered twice unnecessarily.

In order to increase safety for both users in such a case, the motor vehicle 1 may have a monitoring apparatus 14. This monitoring apparatus may be a camera, which may be coupled to an emergency call system, for example. The monitoring apparatus 14 may be activated automatically or manually when required, i.e. in the event of a second user taking along the first user. This increases safety when both users are in the motor vehicle at the same time.

The device proposed here allows a parking position for a motor vehicle to be determined in such a way and a user to be provided with a display indicating that there is a high probability of the first user being able to perform a direct handover of the motor vehicle to a second user, without it being necessary to park the motor vehicle.

### REFERENCE SIGNS

1 motor vehicle
2 device
4 input unit
6 input device
8 processing unit
10 output unit
12 output device
14 monitoring unit

1.-10. (canceled)

11. A device for determining a parking position for a motor vehicle, comprising:
a receiving unit for receiving a desired parking position of a first user;
an output unit for outputting a parking position for the motor vehicle of the first user; and
a processing unit that is configured to take historical data and current data as a basis for determining a probability of the desired parking position of the first user matching the desired pickup position of a second user, and that is configured to determine a parking position for the motor vehicle of the first user on the basis of the probability, wherein
the output unit is configured to output the parking position.

12. The device according to claim 11, wherein
the processing unit is further configured to determine the parking position in a predefined area around the desired parking position of the first user.

13. The device according to claim 11, wherein
the parking position is determined such that the probability of the parking position matching a desired pickup position of a second user is above a defined threshold.

14. The device according to claim 11, wherein
the historical data include information about actual pickup positions and/or parking positions of motor vehicles in the past, the information containing temporal and/or geographical information.

15. The device according to claim 11, wherein
the processing unit is further configured to determine the parking position by using geographical information.

16. The device according to claim 15, wherein
the geographical information comprises parking areas and/or road sizes.

17. The device according to claim 11, wherein
the processing unit is further configured to:
compare the desired parking position of the first user with a current desired pickup position of a second user, and
use the comparison as a basis for determining the parking position.

18. The device according to claim 17, wherein
the processing unit is further configured to:
compare a route from a current position of the first user to the desired parking position of the first user with a route from the desired pickup position of the second user to the desired parking position of the first user, and
use the comparison as a basis for stipulating the parking position along the route from the desired pickup position of the second user to the desired parking position of the first user.

19. The device according to claim 11, wherein
the processing unit is further configured to determine the probability of the desired parking position of the first user matching the desired pickup position of a second user on the basis of already known future desired pickup positions.

20. A motor vehicle comprising a device for determining a parking position for the motor vehicle according to claim 11.

21. The motor vehicle according to claim 20, wherein the motor vehicle further comprises a monitoring unit for monitoring an interior of the motor vehicle.
